(19) United States
(12) Patent Application Publication
(10) Pub. No.: US 2010/0103689 A1
(43) Pub. Date: Apr. 29, 2010

(54) LAMP DEVICE FOR AN AUTOMOBILE

(75) Inventors: Cheng-Shih LEE, Taipei Hsien (TW); Hsin-Yi HSIEH, Taipei Hsien (TW); Chou-Chih YIN, Taipei Hsien (TW)

Correspondence Address: LADAS & PARRY LLP, 224 SOUTH MICHIGAN AVENUE, SUITE 1600, CHICAGO, IL, 60604, US

(73) Assignee: BRIGHT LED ELECTRONICS CORP., Taipei Hsien (TW)

(21) Appl. No.: 12/604,510

(22) Filed: Oct. 23, 2009

(30) Foreign Application Priority Data
Oct. 24, 2008 (TW) 097140975

(51) Int. Cl. B60Q 1/26

(52) U.S. Cl. 362/487

(57) ABSTRACT

A lamp device includes a lamp housing embedded in an automobile body. The lamp housing has an outer housing part coupled to and disposed outwardly around an inner housing part. The outer housing part has a thermal conductivity coefficient less than that of the inner housing part. A transparent lamp cap is mounted to the lamp housing, is exposed from the automobile body, and cooperates with the inner housing part of the lamp housing to define a first inner space therebetween. A lighting module is disposed in the first inner space, and includes at least one light emitting diode.

### CROSS-REFERENCE TO RELATED APPLICATION

This application claims priority of Taiwanese Application No. 097140975, filed on Oct. 24, 2008.

### BACKGROUND OF THE INVENTION

1. Field of the Invention

The invention relates to a lamp device, more particularly to a lamp device for an automobile.

2. Description of the Related Art

Referring to FIG. 1, a conventional head lamp device 1 for an automobile is shown to include a lamp housing 11 embedded in an automobile body 100 of the automobile and having a front open side, a transparent lamp cap 12 mounted on the front open side of the lamp housing 11 and cooperating with the lamp housing 11 to define an inner space 10, a heat-conductive base unit 13 disposed in the inner space 10 and including a plurality of heat-dissipating fins 131, and a plurality of light emitting diodes 14 mounted on the base unit 13.

In use, heat generated by the light emitting diodes 14 is dissipated outside through the lamp cap 12 using cool air flowing toward the lamp cap 12. Therefore, the conventional head lamp device 1 has a poor heat dissipating efficiency. Moreover, when the automobile is activated, heat radiated by an engine (not shown) is conducted to the lamp housing 11, thereby increasing temperature of the inner space 10. As a result, the service life of the conventional lamp device 1 is adversely affected.

### SUMMARY OF THE INVENTION

Therefore, an object of the present invention is to provide a lamp device for an automobile that can overcome the aforesaid drawback of the prior art.

According to the present invention, there is provided a lamp device for an automobile. The lamp device comprises:

a lamp housing adapted to be embedded in an automobile body of the automobile and including an inner housing part, and an outer housing part coupled to and disposed outwardly around the inner housing part, the outer housing part having a thermal conductivity coefficient less than that of the inner housing part;

a transparent lamp cap mounted to the lamp housing, adapted to be exposed from the automobile body and cooperating with the inner housing part of the lamp housing to define a first inner space therebetween; and

a lighting module disposed in the first inner space and including at least one light emitting diode.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic sectional view of a conventional head lamp device for an automobile;

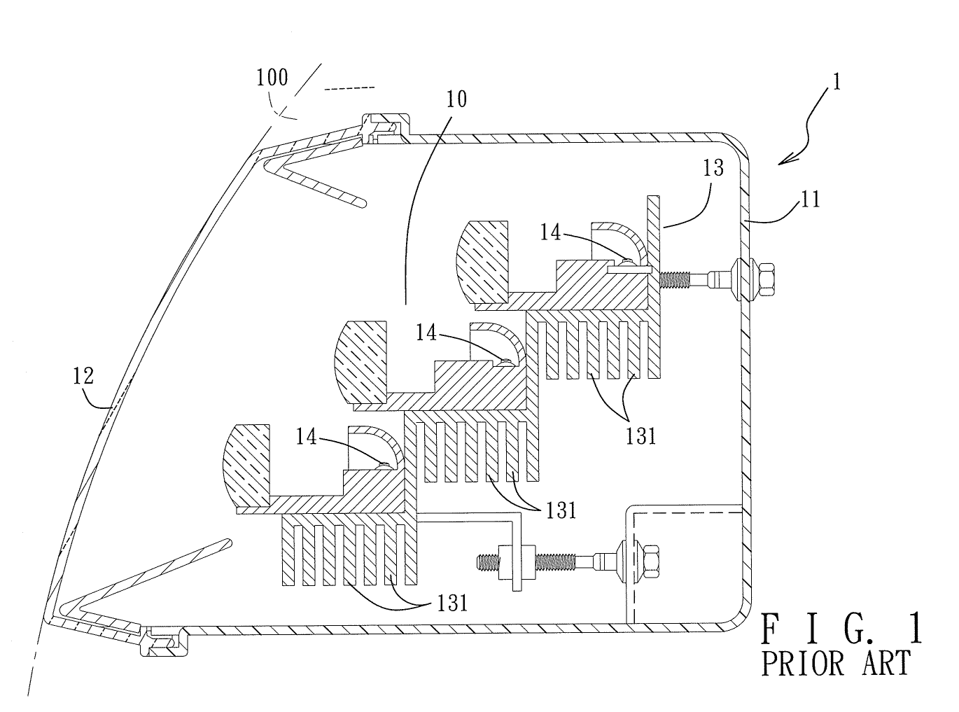

FIG. 2 is a schematic sectional view showing the first preferred embodiment of a lamp device for an automobile according to the present invention;

FIG. 3 is a schematic sectional view showing the second preferred embodiment of a lamp device for an automobile according to the present invention;

FIG. 4 is a schematic sectional view showing the third preferred embodiment of a lamp device for an automobile according to the present invention; and

FIG. 5 is a schematic sectional view showing the fifth preferred embodiment of a lamp device for an automobile according to the present invention.

### DETAILED DESCRIPTION OF THE PREFERRED EMBODIMENTS

Before the present invention is described in greater detail, it should be noted that like elements are denoted by the same reference numerals throughout the disclosure.

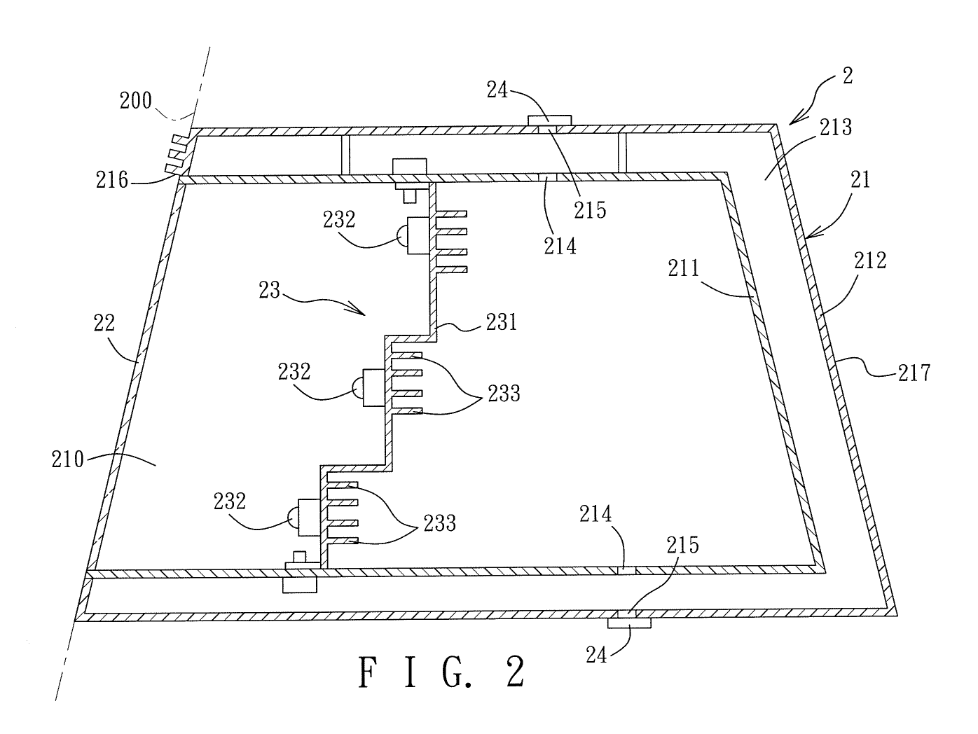

Referring to FIG. 2, the first preferred embodiment of a lamp device 2 for an automobile according to the present invention is shown to include a lamp housing 21, a transparent lamp cap 22, and a lighting module 23.

The lamp housing 21 is adapted to be embedded in an automobile body 200 of the automobile, and includes an inner housing part 211, and an outer housing part 212 coupled to and disposed outwardly around the inner housing part 211. The outer housing part 212 has a thermal conductivity coefficient less than that of the inner housing part 211. In this embodiment, each of the inner and outer housing parts 211, 212 is made of plastic material. The thermal conductivity coefficient of the inner housing part 211 is not less than 50 W/mK, and the thermal conductivity coefficient of the outer housing part 212 is not greater than 5 W/mK. Preferably, the thermal conductivity coefficients of the inner and outer housing parts 211, 212 are 100 W/mK and 2 W/mK, respectively. The inner housing part 211 is U-shaped in cross section. In this embodiment, the lamp housing 21 has an open side 216 adapted to be exposed from the automobile body 200. The lamp cap 22 is mounted on the open side 216, and cooperates with the inner housing part 211 to define a first inner space 210 therebetween. The inner housing part 211 cooperates with the outer housing part 212 to define a second inner space 213. The inner housing part 211 is formed with a plurality of first through holes 214 so that the first inner space 210 is in spatial communication with the second inner space 213 via the first through holes 214. The outer housing part 212 is formed with a plurality of second through holes 215 in spatial communication with the second inner space 213.

The lighting module 23 is disposed in the first inner space 210, and includes a heat-conductive base 231, a plurality of light emitting diodes 232 mounted on the heat-conductive base 231, and a plurality of heat-dissipating fins 233 connected integrally to the heat-conductive base 231.

The lamp device 2 further includes a plurality of filter members 24, such as filter nets, mounted on the outer housing part 212 for filtering air into the second inner space 213 through the second through holes 215. Due to the presence of filter member 24, accumulation of dust on the heat-dissipating fins 233 can be prevented, thereby ensuring heat-dissipating efficiency of the heat-dissipating fins 233.

In use, when the lamp device 2 serves as a head lamp device, since the thermal conductivity coefficient of the outer housing part 212 is relatively low, heat radiated by an engine of the automobile during activation can be effectively isolated from the lamp housing 21. On the other hand, since the thermal conductivity coefficient of the inner housing part 211 is relatively high, heat generated by the light emitting diodes 232 can be effectively conducted to the inner housing part 211. Moreover, hot air in the first inner space 210 can flows into the second inner space 213 through the first through holes 214 such that temperature in the lamp housing 21 is uniform. As a result, the lamp device 2 of this invention has a superior heat dissipating efficiency, thereby ensuring the service life thereof.

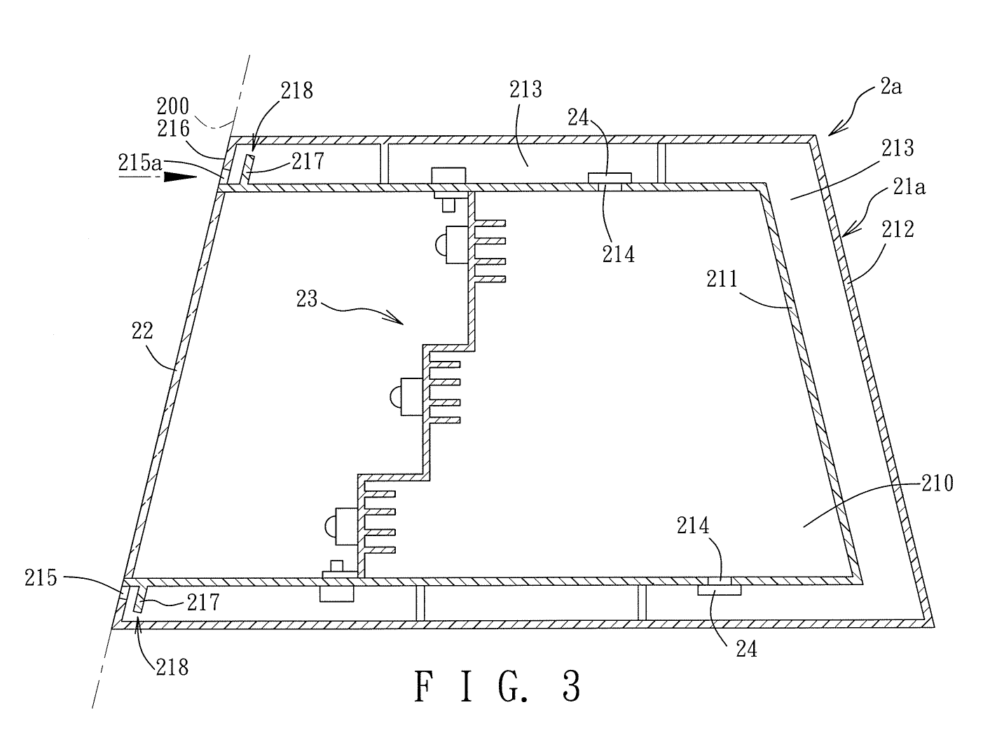

FIG. 3 illustrates the second preferred embodiment of a lamp device (2a) for an automobile according to this invention, which is a modification of the first preferred embodiment. In this embodiment, the second through holes (215a) are formed in the open side 216 of the lamp housing (21a) and are disposed adjacent to the lamp cap 22.

It is noted that the lamp housing (21a) further includes a plurality of blocking pieces 217 mounted in the second inner space 213. In this embodiment, each of the blocking pieces 217 is disposed adjacent to a corresponding one of the through holes (215a) in the open side 216 of the lamp housing (21a), and is connected integrally to the inner housing part 211 so that a gap 218 is formed between a corresponding one of the blocking pieces 217 and the outer housing part 212, and is distal from the corresponding one of the second through holes (215a) in the open side 216 of the lamp housing (21a). Due to the presence of the blocking pieces 217, insects can be prevented from entering into the second inner space 213. Furthermore, in this embodiment, the filter members 24 are mounted on the inner housing part 211 of the lamp housing (21a) for filtering air into the first inner space 210 through the first through holes 214 in the inner housing part 211.

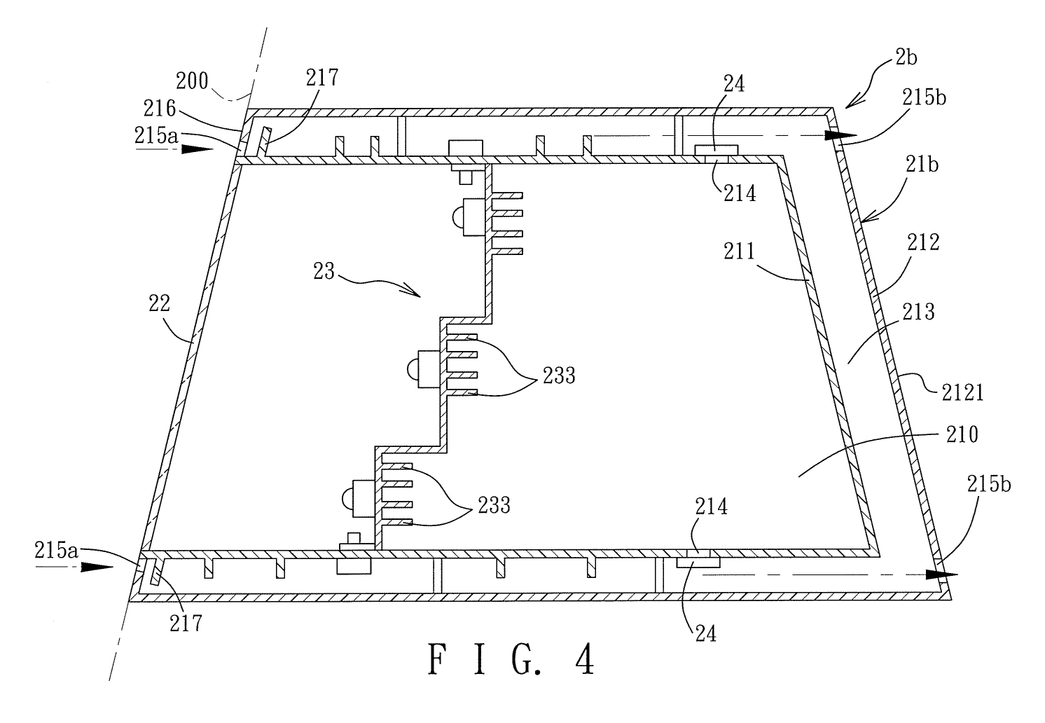

FIG. 4 illustrates the third preferred embodiment of a lamp device (2b) for an automobile according to this invention, which is a modification of the second preferred embodiment. In this embodiment, the outer housing part 212 has a side 2121 opposite to the open side 216 of the lamp housing (21b) and formed with a plurality of third through holes (215b). As a result, external cool air flows into the second inner space 213 via the second through holes (215a), absorbs heat accumulated in the second inner space 213, and flows out of the outer housing part 212 via the third through holes (215b), thereby enhancing the heat dissipating efficiency of the lamp device (2b) of this invention.

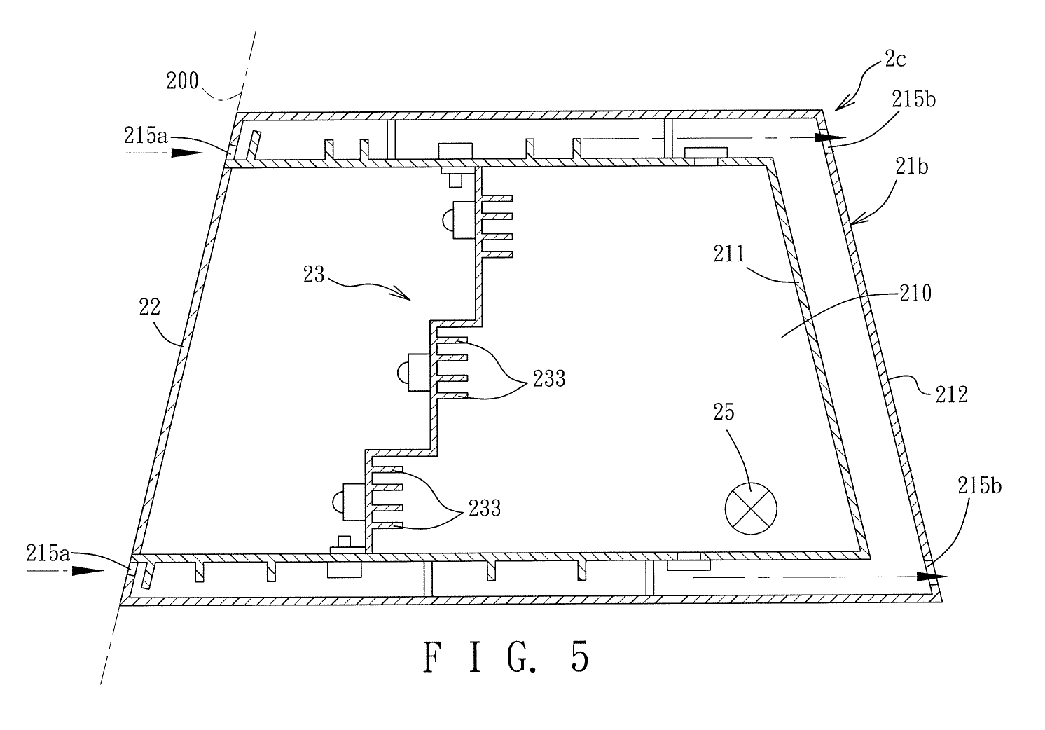

FIG. 5 illustrates the fourth preferred embodiment of a lamp device (2c) for an automobile according to this invention, which is a modification of the third preferred embodiment. In this embodiment, the lamp device (2c) further includes a fan unit 25 disposed in the first inner space 210.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A lamp device for an automobile, comprising:
a lamp housing adapted to be embedded in an automobile body of the automobile and including an inner housing part, and an outer housing part coupled to and disposed outwardly around said inner housing part, said outer housing part having a thermal conductivity coefficient less than that of said inner housing part;
a transparent lamp cap mounted to said lamp housing, adapted to be exposed from the automobile body and cooperating with said inner housing part of said lamp housing to define a first inner space therebetween; and
a lighting module disposed in said first inner space and including at least one light emitting diode.

2. The lamp device as claimed in claim 1, wherein said lighting module further includes a heat-conductive base mounted with said light emitting diode thereon, and a plurality of heat-dissipating fins connected integrally to said heat-conductive base.

3. The lamp device as claimed in claim 1, wherein:
said inner housing part cooperates with said outer housing part to define a second inner space therebetween; and
said inner housing part of said lamp housing is formed with at least one first through hole so that said first inner space is in spatial communication with said second inner space via said first through hole.

4. The lamp device as claimed in claim 3, wherein said outer housing part of said lamp housing is formed with at least one second through hole in spatial communication with said second inner space in said lamp housing.

5. The lamp device as claimed in claim 4, further comprising a filter member mounted on said outer housing part of said lamp housing for filtering air into said second inner space in said lamp housing through said second through hole in said outer housing part.

6. The lamp device as claimed in claim 3, wherein said lamp housing has an open side adapted to be exposed from the automobile body, mounted with said lamp cap thereon, and formed with a plurality of second through holes in spatial communication with said second inner space in said lamp housing.

7. The lamp device as claimed in claim 6, wherein said lamp housing further includes a plurality of blocking pieces mounted in said second inner space, each of said blocking pieces being disposed adjacent to a corresponding one of said second through holes in said open side of said lamp housing, and being connected integrally to one of said inner and outer housing parts so that a gap is formed between a corresponding one of said blocking pieces and the other one of said inner and outer housing parts and is distal from the corresponding one of said second through holes in said open side of said lamp housing.

8. The lamp device as claimed in claim 6, wherein said outer housing part of said lamp housing is formed with a plurality of third through holes.

9. The lamp device as claimed in claim 8, wherein said outer housing part of said lamp housing has a side opposite to said open side of said lamp housing and formed with said third through holes.

10. The lamp device as claimed in claim 6, further comprising a filter member mounted on said inner housing part of said lamp housing for filtering air into said first inner space through said first through hole in said inner housing part.

11. The lamp device as claimed in claim 1, further comprising a fan unit disposed in said first inner space.

12. The lamp device as claimed in claim 1, wherein the thermal conductivity coefficient of said inner housing part of said lamp housing is not less than 50 W/mK.

13. The lamp device as claimed in claim 1, wherein the thermal conductivity coefficient of said outer housing part of said lamp housing is not greater than 5 W/mK.
